(19) United States
(12) Patent Application Publication
(10) Pub. No.: US 2024/0046121 A1
(43) Pub. Date: Feb. 8, 2024

(54) STATE DETERMINATION APPARATUS USING MACHINE LEARNING MODEL, DETERMINATION METHOD, AND STORAGE MEDIUM

(71) Applicant: NEC Corporation, Tokyo (JP)

(72) Inventors: Eiji YUMOTO, Tokyo (JP); Masahiro HAYASHITANI, Tokyo (JP); Takeshi HASEGAWA, Tokyo (JP); Yuki KOSAKA, Tokyo (JP)

(73) Assignee: NEC Corporation, Tokyo (JP)

(21) Appl. No.: 18/382,148

(22) Filed: Oct. 20, 2023

Related U.S. Application Data
(63) Continuation of application No. 18/222,401, filed on Jul. 14, 2023.

(30) Foreign Application Priority Data
Jul. 22, 2022 (JP) 2022-117512

(51) Int. Cl. G06N 5/022; G06N 20/00

(52) U.S. Cl. CPC G06N 5/022; G06N 20/00

(57) ABSTRACT

In order to achieve an object to determine, with high accuracy, that a target is in a specific state, a state determination apparatus includes: a calculation section that calculates, on the basis of data obtained from the target, a score indicative of a degree to which the target is in the specific state; a decision section that decides a threshold on the basis of the data; and a determination section that determines, by comparing the score and the threshold, whether the target is in the specific state.

This is a Continuation of U.S. patent application Ser. No. 18/222,401 filed Jul. 14, 2023, which claims priority under U.S.C. § 119 on Patent Application No. 2022-117512 filed in Japan on Jul. 22, 2022, the entire contents of which are hereby incorporated by reference.

### TECHNICAL FIELD

The present invention relates to a technique for determining whether a target is in a specific state.

### BACKGROUND ART

Patent Literature 1 discloses a technique for calculating feature time-series data from biological information of a target patient and outputting an agitation score of the target patient by processing the feature time-series data. In the technique, a numerical value in a range of 0 to 1 is output as the agitation score. The score that has a numerical value closer to 1 indicates agitation, and the score that has a numerical value closer to 0 indicates non-agitation.

### CITATION LIST

### Patent Literature

### Patent Literature 1

International Publication No. WO 2019/044619

### SUMMARY OF INVENTION

### Technical Problem

In order to use the technique disclosed in Patent Literature 1 to determine that a target is in a specific state (agitation), it is necessary to decide a threshold with respect to the agitation score. However, Patent Literature 1 does not discuss this point. Thus, the above technique has room for improvement in order to determine, with high accuracy, that the target is in the specific state.

An example aspect of the present invention has been made in view of the above problems, and an example object thereof is to provide a technique for determining, with high accuracy, that a target is in a specific state.

### Solution to Problem

A state determination apparatus according to an example aspect of the present invention includes at least one processor, the at least one processor carrying out: a calculation process for calculating a score indicative of a degree to which the target is in a specific state, with use of a calculation model that uses target data obtained from a target as an input to output the score, the calculation model being generated by semi-supervised learning; a decision process for deciding a threshold on the basis of the target data with use of at least one prediction model each of which uses the target data as an input to output a calculated value related to the specific state, the at least one prediction model each being a model generated by supervised learning; and a determination process for determining, by comparing the score and the threshold, whether the target is in the specific state.

A determination method according to an example aspect of the present invention includes: (a) calculating a score indicative of a degree to which the target is in a specific state, with use of a calculation model that uses target data obtained from a target as an input to output the score, the calculation model being generated by semi-supervised learning; (b) deciding a threshold on the basis of the target data with use of at least one prediction model each of which uses the target data as an input to output a calculated value related to the specific state, the at least one prediction model each being a model generated by supervised learning; and (c) determining, by comparing the score and the threshold, whether the target is in the specific state, (a), (b), and (c) each being carried out by at least one processor.

A non-transitory storage medium according to an example aspect of the present invention stores therein a program for causing a computer to carry out: a calculation process for calculating a score indicative of a degree to which the target is in a specific state, with use of a calculation model that uses target data obtained from a target as an input to output the score, the calculation model being generated by semi-supervised learning; a decision process for deciding a threshold on the basis of the target data with use of at least one prediction model each of which uses the target data as an input to output a calculated value related to the specific state, the at least one prediction model each being a model generated by supervised learning; and a determination process for determining, by comparing the score and the threshold, whether the target is in the specific state.

### Advantageous Effects of Invention

An example aspect of the present invention makes it possible to provide a technique for determining, with high accuracy, that a target is in a specific state.

### BRIEF DESCRIPTION OF DRAWINGS

FIG. 1 is a block diagram illustrating a configuration of a state determination apparatus according to a first example embodiment of the present invention.

FIG. 2 is a flowchart illustrating a flow of a determination method according to the first example embodiment of the present invention.

FIG. 3 is a block diagram illustrating a configuration of a state determination apparatus according to a second example embodiment of the present invention.

FIG. 4 is a flowchart illustrating a flow of a determination method according to the second example embodiment of the present invention.

FIG. 5 is a diagram illustrating an example of a hardware configuration of a state determination apparatus in accordance with each of the example embodiments of the present invention.

### EXAMPLE EMBODIMENTS

### [First Example Embodiment]

A first example embodiment of the present invention will be described in detail with reference to the drawings. The present example embodiment is an embodiment serving as a basis for example embodiments described later.

### <Configuration of State Determination Apparatus 1>

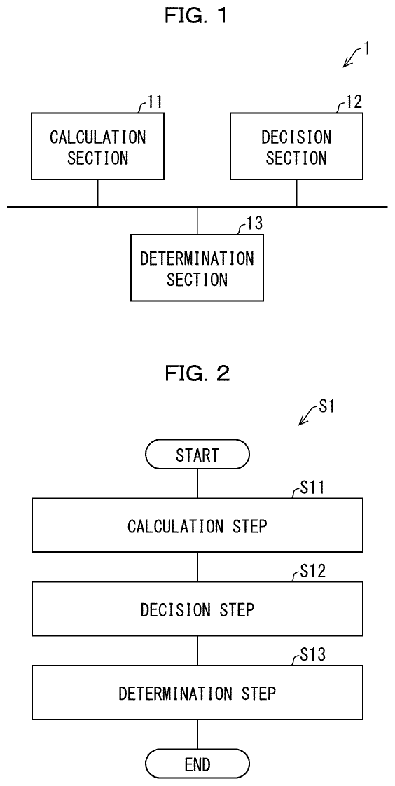

A configuration of a state determination apparatus 1 according to the present example embodiment will be described with reference to FIG. 1. FIG. 1 is a block diagram illustrating the configuration of the state determination apparatus 1. As illustrated in FIG. 1, the state determination apparatus 1 includes a calculation section 11, a decision section 12, and a determination section 13. The calculation section 11 is an example configuration that achieves a calculation means recited in the claims. The decision section 12 is an example configuration that achieves a decision means recited in the claims. The determination section 13 is an example configuration that achieves a determination means recited in the claims.

The calculation section 11 calculates, on the basis of target data obtained from a target, a score indicative of a degree to which the target is in a specific state. The decision section 12 decides a threshold on the basis of the target data. The determination section 13 determines, by comparing the score and the threshold, whether the target is in the specific state.

### <Flow of Determination Method S1>

The state determination apparatus 1 configured as described above carries out a determination method S1 according to the present example embodiment. A flow of the determination method S1 will be described with reference to FIG. 2. FIG. 2 is a flowchart illustrating the flow of the determination method S1. As illustrated in FIG. 2, the determination method S1 includes a calculation step S11, a decision step S12, and a determination step S13. In the calculation step S11, the calculation section 11 calculates, on the basis of target data obtained from a target, a score indicative of a degree to which the target is in a specific state. In the decision step S12, the decision section 12 decides a threshold on the basis of the target data. In the determination step S13, the determination section 13 determines, by comparing the score and the threshold, whether the target is in the specific state.

### <Program Implementation Example>

In a case where the state determination apparatus 1 is constituted by a computer, the following program is stored in a memory referred to by the computer. The program causes the computer to function as: the calculation section 11 that calculates, on the basis of data obtained from a target, a score indicative of a degree to which the target is in a specific state; the decision section 12 that decides a threshold on the basis of the data; and the determination section 13 that determines, by comparing the score and the threshold, whether the target is in the specific state. The determination method S1 described above is realized by the computer reading the program from the memory and executing the program.

### <Effect of Present Example Embodiment>

As described above, in the present example embodiment, a configuration is employed such that a score indicative of a degree to which a target is in a specific state is calculated on the basis of target data obtained from the target, a threshold is decided on the basis of the target data, and it is determined, by comparing the score and the threshold, whether the target is in the specific state. Thus, the state determination apparatus 1 according to the present example embodiment brings about an effect of making it possible to determine, with high accuracy, that a target is in a specific state.

### [Second Example Embodiment]

A state determination apparatus 1A according to a second example embodiment of the present invention will be described in detail with reference to the drawings. Note that members having functions identical to those of the respective members described in the first example embodiment are given respective identical reference numerals, and a description of those members is omitted as appropriate.

### <Overview of State Determination Apparatus 1A>

The state determination apparatus 1A is an apparatus that detects an anomaly in a target on the basis of target data obtained from the target. Note here that “anomaly” is an example of “specific state” recited in the claims. More specifically, the state determination apparatus 1A detects the anomaly in the target with use of a prediction model generated by supervised learning and a calculation model generated by semi-supervised learning. In a case where the state determination apparatus 1A is used, by, for example, generating a prediction model on the basis of a labeled training data group obtained in a certain region, it is possible to detect an anomaly in a target also in another region in which it is impossible to sufficiently obtain a labeled training data group.

Assume, for example, that in a case where a detection target is a patient at a hospital, there is a prediction model derived from a hospital A and generated by supervised learning. Specifically, such a prediction model has been generated by supervised learning on the basis of a labeled training data group obtained from the patient at the hospital A. Note here that in a hospital B, there is a demand for detection of an anomaly in a patient, but it is sometimes difficult to assign labels to all training data groups obtained from a patient at the hospital B. In such a case, the state determination apparatus 1A can detect, with high accuracy, an anomaly in the patient at the hospital B with use of the prediction model derived from the hospital A and generated by supervised learning and a calculation model derived from the hospital B and generated by semi-supervised learning.

In a case where the detection target is a patient, an anomaly to be detected may be a state indicative of a sign that the patient will be agitated (hereinafter referred to as an agitation sign). Training data or target data obtained from the patient may be various kinds of sensor information obtained from at least one sensor worn by the patient. Alternatively, the training data or target data obtained from the patient may be feature information generated from the various kinds of sensor information. Specific examples of the sensor information include heart rate data obtained by, for example, a pulse wave sensor or electrocardiography Holter, and acceleration data obtained by an acceleration sensor. Note, however, that the detection target, the anomaly to be detected, the training data, and the target data are not limited to the specific examples described above.

### <Configuration of State Determination Apparatus 1A>

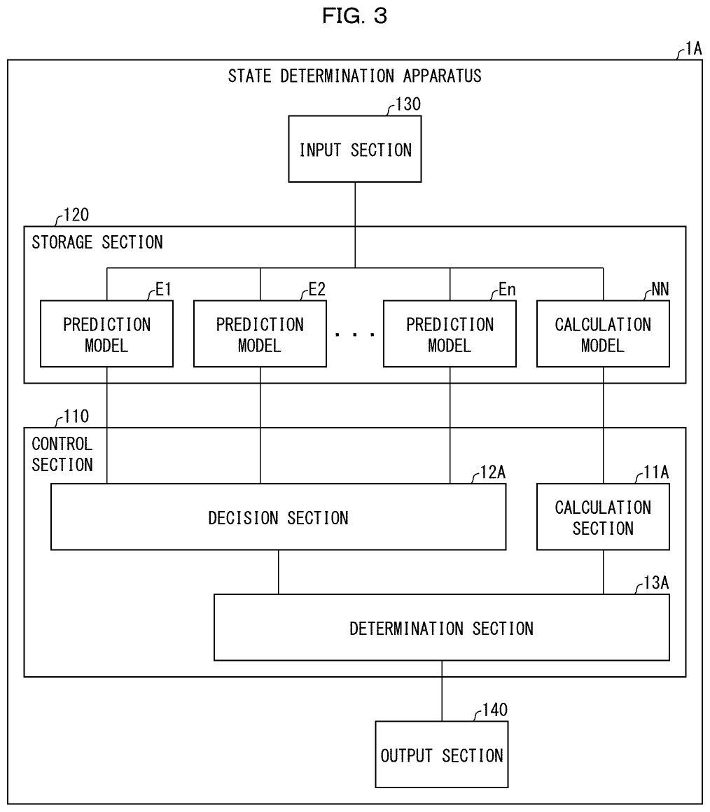

A configuration of the state determination apparatus 1A will be described with reference to FIG. 3. As illustrated in FIG. 3, the state determination apparatus 1A includes a control section 110, a storage section 120, an input section 130, and an output section 140. The control section 110 is constituted by, for example, a processor and collectively controls sections of the state determination apparatus 1A. The control section 110 includes a calculation section 11A, a decision section 12A, and a determination section 13A. These functional blocks and models will be discussed in detail in “Flow of determination method S1A” (described later).

The input section 130 acquires information that is input to the state determination apparatus 1A. The input section 130 may acquire information that is input via, for example, a mouse, a keyboard, or a touchpad. The input section 130 may also acquire, for example, information that is input from, for example, any storage medium or an external apparatus connected via a network.

The output section 140 outputs information in accordance with control by the control section 110. The output section 140 may output information to, for example, a display, a printer, or a loudspeaker. The output section 140 may also output information to, for example, any storage medium or an external apparatus connected via a network.

The storage section 120 is constituted by, for example, a memory and stores therein various data used by the control section 110. The storage section 120 stores therein a prediction model Ei (i=1, 2, . . . , n where n is a natural number of 2 or more) and a calculation model NN. The calculation model NN is a model that is different from any of prediction models E1 to En.

### (Prediction Model Ei)

The prediction model Ei is used by the decision section 12A to decide a threshold. The prediction model Ei uses target data as an input and outputs a calculated value related to an anomaly. Here, the description will be continued assuming that the calculated value is a prediction probability obtained by predicting a probability of a target being anormal. The prediction model Ei is a model generated by supervised learning.

For example, the prediction model Ei is generated by an algorithm Ri for supervised learning with use of a training data group Ai. Specific examples of the algorithm for supervised learning include, but are not limited to, a gradient tree, random forest, and logistic regression.

The training data group Ai includes a plurality of training data. For example, the training data is data obtained from the patient at the hospital A, the patient being a learning target. Specifically, the training data is, for example, various kinds of sensor information obtained from at least one sensor worn by the patient, or feature information generated on the basis of the various kinds of sensor information. The training data group Ai may include training data obtained from a respective plurality of learning targets, or may include a plurality of training data obtained from a single learning target.

Each of the training data included in the training data group Ai is assigned a label indicating presence/absence of an anomaly. For example, a label indicative of presence/absence of an agitation sign is generated in a case where a person who assigns the label inputs presence/absence of the agitation sign while viewing a moving image that includes a patient as a subject. The generated label is associated with training data obtained from the patient in a period that corresponds to a time point at which presence/absence of the agitation sign is input and that is indicated by a moving image which was being viewed at the time point.

Note here that at least one prediction model Ei may be generated with use of the training data group Ai that is different from at least one other prediction model Ej (j=1, 2, . . . n; note that i is not equal to j). In other words, the training data group Ai may be different from a training data group Aj. Note that the training data group Ai and the training data group Aj being different from each other means that at least one piece of training data, the at least one piece being included in one of the training data groups Ai and Aj, is not included in the other of the training data groups Ai and Aj.

For example, a training data group A1 may be collected from a patient in a first area, and a training data group A2 may be collected from a patient in a second area different from the first area. A training data group A3 may be collected from a patient having a first attribute, and a training data group A4 may be collected from a patient having a second attribute different from the first attribute. A training data group A5 may be collected in a first period, and a training data group A6 may be collected in a second period different from the first period. Note that a specific example of the training data group Ai is not limited to the example described above.

The at least one prediction model Ei may be generated with use of the algorithm Ri that is different from the algorithm Rj with use of which the at least one other prediction model Ej is generated. Alternatively, the at least one prediction model Ei may be generated with use of the algorithm Ri which is identical between the at least one prediction model Ei and the at least one other prediction model Ej and to which a parameter that is different from a parameter of the at least one other prediction model Ej is applied. In other words, the algorithm Ri may be different from or identical to an algorithm Rj. In a case where the algorithm Ri is identical to the algorithm Rj, a parameter that is used in the algorithm Ri to generate the prediction model Ei may be different from a parameter that is used in the algorithm Rj to generate the prediction model Ej.

For example, an algorithm R1 may be a gradient tree, and an algorithm R2 may be a gradient tree with a hyperparameter adjusted. An algorithm R3 may be random forest, and an algorithm R4 may be random forest with a hyperparameter adjusted. Note, however, that a specific example of the algorithm Ri is not limited to the example described above.

### (Calculation Model NN)

The calculation model NN is used by the calculation section 11A to calculate a score. The calculation model NN uses, as an input, target data obtained from a target, and outputs an anomaly score indicative of a degree to which the target is anormal. The calculation model NN is generated by semi-supervised learning.

For example, the calculation model NN is generated by semi-supervised learning with use of a training data group B. Specific examples of an algorithm for semi-supervised learning algorithm include, but are not limited to, a deviation network (DevNet).

The training data group B includes a plurality of training data. For example, the training data is data obtained from the patient at the hospital B, the patient being a learning target. Specifically, the training data is, for example, various kinds of sensor information obtained from at least one sensor worn by the patient, or feature information generated on the basis of the various kinds of sensor information. The training data group B may include training data obtained from a respective plurality of learning targets, or may include a plurality of training data obtained from a single learning target.

Some of the training data included in the training data group B are assigned labels indicative of presence/absence of an anomaly, whereas some others of the training data are not assigned any labels. A specific example of label assignment by an operation of a person who assigns a label is similar to the specific example in which the training data group Ai is described.

### <Flow of Determination Method S1A>

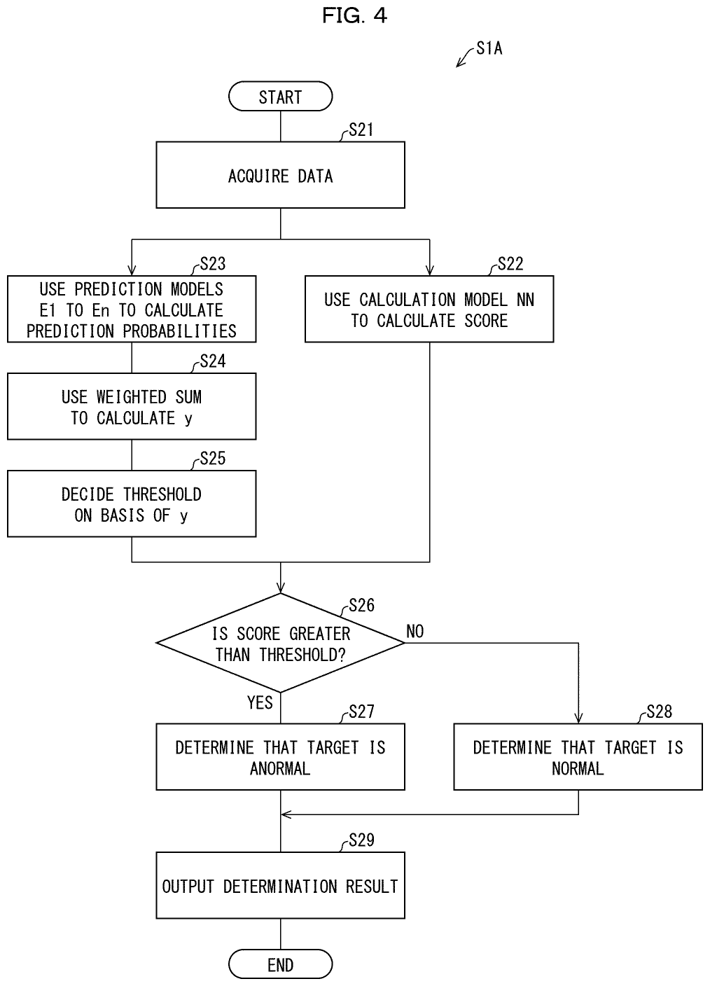

The state determination apparatus 1A configured as described above carries out a determination method S1A according to the present example embodiment. The determination method S1A will be described with reference to FIG. 4. As illustrated in FIG. 4, the determination method S1A includes steps S21 to S29.

In the step S21, the input section 130 acquires target data obtained from a target. Specific examples of the target data include feature information generated from heart rate data and acceleration data of the patient at the hospital B.

In the step S22, the calculation section 11A uses the calculation model NN to calculate an anomaly score of the target data. Specifically, the calculation section 11A inputs the target data to the calculation model NN so as to acquire an anomaly score that is output from the calculation model NN. Specifically, assume, for example, that the calculation model NN is a model generated with use of DevNet and that a prior Gaussian distribution used in learning is N (μ=0, σ²⁼¹).

In the step S23, the decision section 12A uses the prediction models E1 to En to calculate prediction probabilities. Specifically, the decision section 12A inputs the target data to the respective prediction models E1 to En so as to acquire prediction probabilities proba_1, proba_2, . . . , proba_n that are output from the respective prediction models E1 to En. Specifically, assume, for example, that n=2. Assume also that proba_1=0.5 is obtained from the prediction model E1 generated by a gradient tree. Assume also that proba_2=0.5 is obtained from the prediction model E2 generated by a gradient tree with a hyperparameter adjusted.

In the step S24, the decision section 12A uses the following expression (1) to calculate y based on a weighted sum (an example of a value obtained by weighting) of the prediction probabilities output by the respective prediction models E1 to En.

y=1−(w_1*proba_1+w_2*proba_2+ . . . +w_n*proba_n) (1)

where w_1 to w_n are weighting factors that satisfy the following expression (2):

w_i≥0,w_1+w_2+ . . . +w_n≤1 (2)

Thus, a value of 0 to 1 is calculated as y. Note that a weight w_i may be decided on the basis of, for example, an evaluation result obtained by evaluating the prediction model Ei from at least one viewpoint. Such a viewpoint for evaluation may be, for example, a viewpoint based on reliability of the training data group Ai. Alternatively, such a viewpoint for evaluation may be, for example, a viewpoint based on the number of training data included in the training data group Ai. Alternatively, such a viewpoint for evaluation may be, for example, a viewpoint based on accuracy of the prediction model Ei by ex post facto evaluation. Note, however, that such a viewpoint for evaluation is not limited to the example described above.

In the step S25, the decision section 12A decides a threshold threshold_y on the basis of y calculated in the step S24. Note here that y calculated by the expression (1) is applied, as a percentage that is to be determined to be normal, in a prior distribution used in learning of the calculation model NN. Specifically, assume, for example, that n=2, w_1=0.08, and w_2=0.02. In this case, application of w_1=0.08, proba_1=0.5, w_2=0.02, and proba_2=0.5 to the expression (1) results in obtainment of y=0.95. That is, the threshold threshold_y is set such that 95% of the prior distribution is determined to be normal and the top 5% of the prior distribution is determined to be anormal. In the above specific example, since the prior distribution is N (μ=0, σ²⁼¹), threshold_y=μ+z_y*σ=0+1.96*1=1.96 is obtained. Note that z_y is a z value when y is regarded as reliability.

Note an order in which a process in the step S22 and a series of processes in the steps S23 to S25 are carried out is not limited to the order described above. The process in the step S22 and the series of processes in the steps S23 to S25 may be carried out simultaneously, or the process in the step S22 may be carried out after the series of processes in the steps S23 to S25.

In the step S26, the determination section 13A determines whether the anomaly score calculated in the step S22 exceeds the threshold decided in the step S25. In a case where the anomaly score exceeds the threshold (Yes in the step S26), the determination section 13A determines in the step S27 that the target is anormal. In a case where the anomaly score does not exceed the threshold (No in the step S26), the determination section 13A determines in the step S28 that the target is normal.

In the step S29, the output section 140 outputs a determination result in the step S27 or S28. Note that the output section 140 may output a method of response by a medical professional to a target patient (an example of the target), the method being determined on the basis of the determination result. For example, the method of response may be determined on the basis of (i) a model generated by machine-learning a correspondence between (a) the determination result and (b) the method of response and (ii) the determination result for the target patient. A method of determining the method of response is not limited to the above-described method. With this, an action carried out by the medical professional with respect to the target patient can be optimized. This makes it possible to, for example, achieve an improvement in state of the target patient.

### <Effect of Present Example Embodiment>

As described above, according to the present example embodiment, a configuration is employed such that a threshold is determined with use of a prediction probability obtained by inputting, to the respective prediction models E1 to En, target data referred to in order to calculate an anomaly score, and it is determined, by comparing the anomaly score and the threshold, whether a target is anormal. According to the above configuration, it is possible to dynamically decide a threshold on the basis of calculated values calculated by the prediction models E1 to En in accordance with the target data. This makes it possible to increase anomaly detection accuracy in accordance with accuracy of the prediction models E1 to En.

According to the present example embodiment, a configuration is employed such that target data obtained from a target is input to the calculation model NN so as to calculate an anomaly score, the calculation model NN is generated by semi-supervised learning, and the prediction models E1 to En are generated by supervised learning. The above configuration makes it possible to detect an anomaly with high accuracy even in a case where it is impossible to assign labels to all training data groups collected in a region in which an anomaly in a target is desired to be detected. That is, by using (i) the calculation model NN generated by semi-supervised learning in a region in which an anomaly in a target is desired to be detected and (ii) the prediction models E1 to En that are expected to be more highly accurate by supervised learning, it is possible to increase anomaly detection accuracy in the region in which the anomaly in the target is desired to be detected.

According to the present example embodiment, a configuration is employed such that calculated values calculated by the respective prediction models E1 to En are each a prediction probability obtained by predicting a probability of a target being anormal. According to the above configuration, as compared with a case where logistic regression or the like is applied as the prediction model Ei and a calculated value of the logistic regression is used, a threshold can be decided with higher accuracy by, for example, applying, as the prediction model Ei, a gradient tree, random forest, and/or the like with use of which a prediction probability is calculated by ensemble learning, and using the prediction probability.

According to the present example embodiment, a configuration is employed such that the threshold threshold_y of the anomaly score is decided on the basis of a weighted sum of calculated values output by the respective prediction models E1 to En. According to the above configuration, weights of the prediction models E1 to En can be reflected in decision of the threshold threshold_y. This makes it possible to improve accuracy of the threshold threshold_y.

According to the present example embodiment, a configuration is employed such that the prediction model Ei may be generated by an algorithm different from an algorithm by which the prediction model Ej is generated, or may be generated by an algorithm which is identical between the prediction model Ei and the prediction model Ej and to which different parameters are applied. Alternatively, a configuration is employed such that the training data group Ai used to generate the prediction model Ei may be different from the training data group Aj used to generate the prediction model Ej. According to these configurations, prediction probabilities calculated by the prediction models Ei and Ej can be different. This makes it possible to decide the threshold threshold_y from a more diversified viewpoint.

### Variation

In the second example embodiment, the number of prediction models Ei may be one. In this case, 1 is applied as the weighting factor w_1. Also in the case of such a variation, a single prediction model E1 generated with higher accuracy than the calculation model NN can be used to dynamically decide a threshold in accordance with target data. This makes it possible to detect an anomaly in a target with high accuracy.

In the second example embodiment, an example has been described in which the training data groups A1 to An for generating the prediction models E1 to En are collected at the hospital A, and the training data group B for generating the calculation model NN is collected at the hospital B. Note, however, that a region in which the training data groups A1 to An are collected and a region in which the training data group B is collected need not necessarily be different but may be identical. For example, the prediction models E1 to En may be generated with use of the training data groups A1 to An collected at the hospital A in a certain period, and then the training data group B may be collected at the identical hospital A in another period so as to generate the calculation model NN.

In the second example embodiment, an example also has been described in which the training data groups A1 to An for generating the prediction models E1 to En are collected at the identical hospital A. Note, however, that regions in which the training data groups A1 to An are collected need not necessarily be identical. At least one of the training data groups A1 to An may be collected in a region different from a region in which one other of the training data groups A1 to An is collected. For example, the training data group A1 may be collected at the hospital A, and the training data group A2 may be collected at the hospital B, which is different from the hospital A.

In the second example embodiment, an example also has been described in which a specific state to be detected is “anormal”, in particular, “agitation sign of a patient”. However, the specific state is not limited to this. For example, the specific state to be detected may be another state such as “normal” or “deep sleep state”. Furthermore, a detection target is not limited to a living thing such as a human being, and may be a nonliving thing such as a machine or a factory, or a phenomenon such as weather.

### [Software Implementation Example]

Some or all of the functions of the state determination apparatus 1 or 1A may be realized by hardware such as an integrated circuit (IC chip) or may be alternatively realized by software.

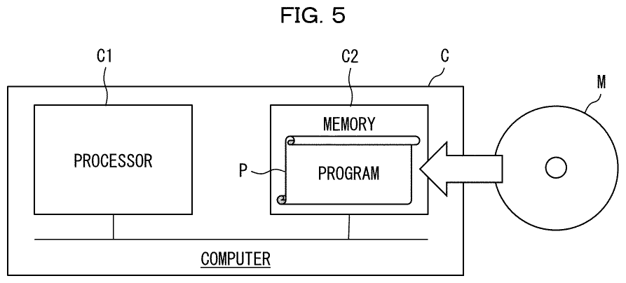

In the latter case, the state determination apparatus 1 or 1A is realized by, for example, a computer that executes instructions of a program that is software realizing the functions. FIG. 5 illustrates an example of such a computer (hereinafter referred to as “computer C”). The computer C includes at least one processor C1 and at least one memory C2. The memory C2 stores a program P for causing the computer C to operate as the state determination apparatus 1 or 1A. In the computer C, the functions of the state determination apparatus 1 or 1A are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

A state determination apparatus including:
a calculation means that calculates, on the basis of target data obtained from a target, a score indicative of a degree to which the target is in a specific state;
a decision means that decides a threshold on the basis of the target data; and
a determination means that determines, by comparing the score and the threshold, whether the target is in the specific state.

### (Supplementary Note 2)

The state determination apparatus according to Supplementary note 1, wherein
the decision means decides the threshold with use of at least one prediction model each of which uses the target data as an input to output a calculated value related to the specific state.

### (Supplementary Note 3)

The state determination apparatus according to Supplementary note 2, wherein
the calculation means calculates the score with use of a calculation model that uses the target data as an input to output the score,
the calculation model having been generated by semi-supervised learning,
the at least one prediction model each being a model generated by supervised learning.

### (Supplementary Note 4)

The state determination apparatus according to Supplementary note 2 or 3, wherein the calculated value that is output by each of the at least one prediction model is a prediction probability obtained by predicting a probability of the target being in the specific state.

### (Supplementary Note 5)

The state determination apparatus according to any one of Supplementary notes 2 to 4, wherein
the at least one prediction model that is used by the decision means comprises a plurality of prediction models, and
the decision means decides the threshold on the basis of a value obtained by assigning weights to calculated values that are output by the respective plurality of prediction models.

### (Supplementary Note 6)

The state determination apparatus according to any one of Supplementary notes 2 to 5, wherein
the at least one prediction model that is used by the decision means comprises a plurality of prediction models, and
at least one of the plurality of prediction models is generated with use of an algorithm that is different from an algorithm with use of which at least one other of the plurality of prediction models is generated, or generated with use of an algorithm which is identical between the at least one of the plurality of prediction models and the at least one other of the plurality of prediction models and to which a parameter that is different from a parameter of the at least one other of the plurality of prediction models is applied.

### (Supplementary Note 7)

The state determination apparatus according to any one of Supplementary notes 2 to 6, wherein
the at least one prediction model that is used by the decision means comprises a plurality of prediction models, and
at least one of the plurality of prediction models is generated with use of a training data group that is different from a training data group with use of which at least one other of the plurality of prediction models is generated.

### (Supplementary Note 8)

A determination method including:
(a) calculating, on the basis of target data obtained from a target, a score indicative of a degree to which the target is in a specific state;
(b) deciding a threshold on the basis of the target data; and
(c) determining, by comparing the score and the threshold, whether the target is in the specific state,
(a), (b), and (c) each being carried out by at least one processor.

### (Supplementary Note 9)

A program for causing a computer to function as:
a calculation means that calculates, on the basis of target data obtained from a target, a score indicative of a degree to which the target is in a specific state;
a decision means that decides a threshold on the basis of the target data; and
a determination means that determines, by comparing the score and the threshold, whether the target is in the specific state.

### (Supplementary Note 10)

A state determination apparatus including at least one processor, the at least one processor carrying out: a calculation process for calculating, on the basis of target data obtained from a target, a score indicative of a degree to which the target is in a specific state; a decision process for deciding a threshold on the basis of the target data; and a determination process for determining, by comparing the score and the threshold, whether the target is in the specific state.

Note that the state determination apparatus may further include a memory, which may store a program for causing the at least one processor to carry out the calculation process, the decision process, and the determination process. The program may be stored in a computer-readable non-transitory tangible storage medium.

### REFERENCE SIGNS LIST

1, 1A State determination apparatus
11, 11A Calculation section
12, 12A Decision section
13, 13A Determination section
110 Control section
120 Storage section
130 Input section
140 Output section
C1 Processor
C2 Memory

1. A state determination apparatus comprising at least one processor, the at least one processor carrying out:
a calculation process for calculating a score indicative of a degree to which a target patient is in an anomaly state, with use of a calculation model that uses target data obtained from the target patient as an input to output the score, the calculation model being generated by semi-supervised learning;
a decision process for deciding a threshold on the basis of the target data with use of at least one prediction model each of which uses the target data as an input to output a calculated value related to the anomaly state, the at least one prediction model each being a model generated by supervised learning; and
a determination process for determining, by comparing the score and the threshold, whether the target patient is in the anomaly state,
the target data including (i) heart rate data obtained by a pulse wave sensor or electrocardiography Holter worn by the target patient and (ii) acceleration data obtained by an acceleration sensor worn by the target patient.

2. The state determination apparatus according to claim 1, wherein the calculated value that is output by each of the at least one prediction model is a prediction probability obtained by predicting a probability of the target patient being in the anomaly state.

3. The state determination apparatus according to claim 1, wherein
the at least one prediction model that is used in the decision process comprises a plurality of prediction models, and
in the decision process, the at least one processor decides the threshold on the basis of a value obtained by assigning weights to calculated values that are output by the respective plurality of prediction models.

4. The state determination apparatus according to claim 1, wherein
the at least one prediction model that is used in the decision process comprises a plurality of prediction models, and
at least one of the plurality of prediction models is generated with use of an algorithm that is different from an algorithm with use of which at least one other of the plurality of prediction models is generated, or generated with use of an algorithm which is identical between the at least one of the plurality of prediction models and the at least one other of the plurality of prediction models and to which a parameter that is different from a parameter of the at least one other of the plurality of prediction models is applied.

5. The state determination apparatus according to claim 1, wherein
the at least one prediction model that is used in the decision process comprises a plurality of prediction models, and
at least one of the plurality of prediction models is generated with use of a training data group that is different from a training data group with use of which at least one other of the plurality of prediction models is generated.

6. The state determination apparatus according to claim 1, wherein
the at least one processor further carries out an output process for outputting (i) a result of determination by the determination process and (ii) a method of responding to the target patient for optimization of an action of a medical professional, the method being determined on the basis of the result of determination.

7. A determination method comprising:
(a) calculating a score indicative of a degree to which a target patient is in an anomaly state, with use of a calculation model that uses target data obtained from the target patient as an input to output the score, the calculation model being generated by semi-supervised learning;
(b) deciding a threshold on the basis of the target data with use of at least one prediction model each of which uses the target data as an input to output a calculated value related to the anomaly state, the at least one prediction model each being a model generated by supervised learning; and
(c) determining, by comparing the score and the threshold, whether the target patient is in the anomaly state,
the target data including (i) heart rate data obtained by a pulse wave sensor or electrocardiography Holter worn by the target patient and (ii) acceleration data obtained by an acceleration sensor worn by the target patient,
(a), (b), and (c) each being carried out by at least one processor.

8. A non-transitory storage medium storing therein a program for causing a computer to carry out:
a calculation process for calculating a score indicative of a degree to which a target patient is in an anomaly state, with use of a calculation model that uses target data obtained from the target patient as an input to output the score, the calculation model being generated by semi-supervised learning;
a decision process for deciding a threshold on the basis of the target data with use of at least one prediction model each of which uses the target data as an input to output a calculated value related to the anomaly state, the at least one prediction model each being a model generated by supervised learning; and
a determination process for determining, by comparing the score and the threshold, whether the target patient is in the anomaly state,
the target data including (i) heart rate data obtained by a pulse wave sensor or electrocardiography Holter worn by the target patient and (ii) acceleration data obtained by an acceleration sensor worn by the target patient.
